(19) United States
(12) Patent Application Publication
(10) Pub. No.: US 2003/0085295 A1
(43) Pub. Date: May 8, 2003

(54) Method for using a liquid jet cutting device and a nozzle for a liquid jet cutting device

(76) Inventors: Henk Dijkman, Zwolle (NL); Paulus Antonius Jacobus Janitschek, Meerhout (BE)

Correspondence Address: PEACOCK MYERS AND ADAMS P C, P O BOX 26927, ALBUQUERQUE, NM, 871256927

(21) Appl. No.: 10/174,274

(22) Filed: Jun. 17, 2002

Related U.S. Application Data
(63) Continuation of application No. PCT/NL00/00929, filed on Dec. 18, 2000.

(30) Foreign Application Priority Data
Dec. 17, 1999 (NL) 1013880

(51) Int. Cl. B05D 1/00; B05B 17/00; B05B 1/00

(52) U.S. Cl. 239/1; 239/589

(57) ABSTRACT

The invention relates to a method for using a liquid-jet cutting device, comprising the separate delivery of a pressurized liquid medium and an abrasive medium to a nozzle, characterized in that the abrasive medium is fed to the nozzle as suspension in a liquid. Preferably the suspension is fed to the nozzle virtually without pressure or under low pressure. The invention also relates to a nozzle for a liquid-jet cutting device.

The present application related to a method for using a liquid-jet cutting device, comprising separately delivering a pressurized liquid medium and an abrasive medium to a nozzle.

Such a method is generally known in the art and is used for cutting materials such as metal, ceramic, plastic, natural materials, etc. with the aid of water jets chat comprise an abrasive to provide the cutting action. For example, a nozzle for a liquid-jet cutting device is available on the market, comprising inlets for a pressurized liquid and for an abrasive, which two inlets are in communication with one outlet. In such a nozzle the liquid is fed under high pressure to the liquid inlet of the nozzle. The liquid is subsequently conducted through a duct and then enters a chamber. Also conducted into this chamber is the abrasive, i.e. sand that is suspended in a gas, i.e. air. The liquid jet is oriented at a second duct positioned in the extended direction of the first duct. When the liquid jet passes through the chamber, it will entrain a quantity of air and sand into the second duct, said quantity being subject to, among other things, the velocity or the liquid jet, the pressure of the gas-abrasive mixture, and the diameter of the jet. In the second duct mixing of the liquid, the gas and the abrasive will take place, thereby capacitating the mixture to cut material of a certain thickness.

Incidentally, the invention is not limited to the use of water as liquid; any suitable liquid may be used. However, for the sake of simplicity the term ‘water’ will mostly be used in the specification and the claims.

Practice has shown that a number or problems are attached to such a method. When the liquid jet, which is pressurized to approximately 3500 bars, enters the mixing chamber, it spreads. Possibly the extent of spreading depends on the pressure in the chamber and on the amount of abrasive contained therein. Similarly, when the mixture leaves the second duct, the cutting jet also spreads considerably. The result is that at increasing distance from the outlet of the nozzle, the cutting power of the jet diminishes relatively quickly. It is thus not possible to realize deep cuts, so that the thickness to be cut and the speed of cutting the material become relatively limited. Moreover, it is not possible to make narrow cuts.

The object of the invention therefore is to provide a method by which the above-mentioned disadvantages are avoided. Other advantages of the present invention will become apparent from the specification.

The above-mentioned objects are achieved with the aid of a method as mentioned in the preamble, and which is characterized in that the abrasive medium is delivered to the nozzle as suspension in a liquid.

In accordance with a preferred embodiment of the method, the distance from the outlet of the nozzle to the object to be cut is varied; this is in fact a vertical displacement, and may be combined with a horizontal movement along the object to be cut. This vertical displacement may be achieved by moving the nozzle, in relation to the object, at least once in the direction of the material, or by moving it up and down several times during cutting, so that the nozzle makes an oscillating movement. Clearly, this effect can be obtained by an actual movement of only the nozzle or only the object, but a movement of both is also possible.

It has been shown that the method according to the invention greatly improves the cutting process. For example, there is much less spreading of the jet at the outlet of the nozzle, and it is possible to work with very small cutting jet diameters. This allows very thick objects to be cut and to obtain very high cutting speeds. Also, by using the present method the drilling of pinpoint holes in material becomes quite a good prospect.

An improved cutting action may ba obtained especially with the previously mentioned oscillating method, wherein a cutting operation is carried out only during the vertical movement of the nozzle toward the material. If no vertical movement takes place, there will be no cutting operation. This allows the nozzle (the cutter head) to be moved ever the object to be cut without consequence, and to carry out cutting operations only on the intended places.

By positioning the cutter head at a permanent position above the object to be cut, and by inducing a short vertical movement, one single brief cutting operation is carried out. In this way, for example, a hole can be made in the object, the diameter of the hole depending, among other things, on the diameter and the speed of the liquid jet. With thicker material it may be necessary to repeat these operations several times in succession in order to obtain a hole all the way through.

It has also been shown, that it is advantageous if the suspension of the abrasive medium in a liquid is entrained as a result of shearing forces caused by the pressurized liquid jet. In this case is not per se necessary to feed pressurized suspension to the nozzle, since this is entrained by the shearing forces generated by the pressurized liquid jet. However, it is possible to supply the suspension by means of compression.

The very great advantage obtained by a method according to the present invention is moreover the fact that the suspension of the abrasive and a liquid does not need to be highly pressurized. Especially pumps suffer greatly when they have to retain a very highly pressurized abrasive suspension. According to the present invention it is possible to simply conduct the abrasive suspension from a storage vat situated above the nozzle to the nozzle by means of gravitational force, or by means of a low-pressure metering system. The suspension is then entrained as a result or shearing force due to the high velocity liquid jet. Some overpressure present will be provided because of the suspension being located at a higher level, or by the low-pressure metering system.

It is also advantageous to intermix the suspension and the liquid of the pressurized liquid jet in an outlet duct of the nozzle. The best possible mixing of the two media is obtained when the liquid of the pressurized liquid jet and the liquid of the suspension are same. For example, the two liquids may be water.

The method may be carried out very well with a nozzle for a liquid-jet cutting device, as mentioned previously, wherein the same comprises a substantially cylindrical configuration consisting of a wall portion and a coaxial passage extending from one and forming the inlet side for the liquid to an opposite end forming the outlet side, with the inlet for the abrasive being positioned between the said ends. It is especially advantageous if the nozzle is designed such that the abrasive may be fed as a suspension in a liquid.

According to the invention it is possible to form a nozzle for a liquid-jet cutting device, as mentioned previously, integrally to include a pre-mounted high-pressure nozzle (for example, a glued-in sapphire, such as known in the field of technology). The nozzles currently used in the technology are comprised of several parts. The outlet duct, through which the liquid, the gas, and the abrasive medium are conducted, is attached to a mixing chamber as separate part, into which the abrasive mixture, i.e. sand, is fed together with air. As the abrasive in the gas-abrasive mixture must not be allowed to precipitate since this could result in obstructions, said mixing chamber needs to have, for example, a suitable form, or needs to comprise, for example, provisions for retaining the abrasive in suspension. To this mixer a jet-producing part is attached in which the pressurized liquid is transferred into a high-velocity liquid jet that can be directed through the mixing chamber. To this end said part may be provided with, for example, a substantially cylindrical passage extending from the inlet for the liquid to the mixing chamber.

As mentioned before, the nozzle is preferably made in one piece. In that case the first duct extending from the inlet to the mixing chamber may be produced substantially simultaneously with the second duct extending from the mixing chamber to the outlet, for example, by drilling or in any other manner appropriate for forming extensive passages through a solid material. This will provide the simplest and most secure manner for aligning the second duct with the first duct.

It has been shown that such a substantially perfect alignment provides the advantage that the “first” liquid jet that may be formed by a sapphire will not actually ally contact the wall of the first or second duct. Said “first” jet will therefore pass through the mixing chamber without any appreciable entrainment of abrasive mixture. The small amount that does become entrained “trickles” out via the first jet from the nozzle. Indeed, in such case, no cutting effect is obtained. However, if the nozzle is moved up and down at a slight distance from the object to be cut, a cutting effect is suddenly obtained. According to an unproven explanation, this is due to the fact that the outer circumference or the first jet becomes disrupted because of the vertical movement. Possibly this causes the abrasive mixture to be entrained in an amount or in a manner such that as a consequence a cutting effect is obtained. This process is not yet understood at present.

Since the nozzle according to the invention is suitable to receive an abrasive medium in the form of a liquid suspension, and said suspension may be supplied at a pressure of, for example, 0.01 MPa (absolute) to, for example, 10 MPa (absolute), it is not necessary to provide special connections. This is in particular the case when the suspension is provided with additives, i.e. emulsifiers for keeping the abrasive in suspension. In that case there is no, or only a minuscule chance of the abrasive precipitating.

Another extra advantage is that the cutting jet is less likely to broaden when leaving the outlet of the cutting nozzle. A possible reason for this is, that no gas is being entrained in the cutting jet. In the present-day technology, the mixed cutting jet which in addition to liquid and abrasive also comprises a gas, will have a particular pressure in the outlet duct that is higher than the atmospheric pressure. On exiting the outlet duct, the gas present will therefore expand, which results in a broadening of the liquid jet. Since there is no gas in the cutting jet in the method according to the invention, such broadening will to a large extent be avoided. This means that narrower cutting widths can be achieved than has been possible so far. Moreover, it has been shown that in accordance with the invention it is possible to work with pressures that are lower than those used up to now, while obtaining the same or even improved cutting depths and cutting speeds. This means a great saving in costs for the necessary equipment.

According to the above-described preferred embodiment, if the first and second ducts are aligned properly, the jet formed by the sapphire will not contact the wall of the ducts, so that the same will also broaden to a lesser extent after exiting the second duct.

Hereinbelow a brief description of the drawings is given, illustrating a nozzle according to the invention.

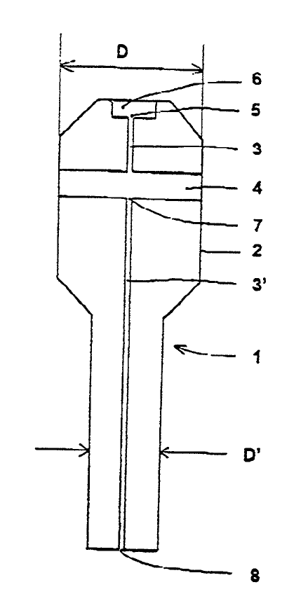

FIG. 1 shows a nozzle 1 for a liquid cutting apparatus (not shown), comprising a substantially elongated cylindrical body 2 and a coaxially oriented passage 3. The coaxial passage 3 is interrupted by a passage 4 oriented perpendicularly to the axis or the passage 3. Via the inlet opening 5 of the passage 3 a liquid, i.e. water may be fed under high pressure into the passage 3 at the topside in the figure. Near said inlet opening 5 a recess 6 may be provided in the body 2, oriented coaxially with the passage 3 and in its extended direction, in which, for example, a sapphire (not shown) may be provided. The inclusion of a sapphire is known in the art. These two form an inseparable entity by means of, for example, gluing. The sapphire preferably comprises a cylindrical passage, but a somewhat elliptical passage is also possible. The passage through the nozzle preferably has the same form as the sapphire.

When via the inlet opening 5 a highly pressurized liquid at, for example, 3500 bars is fed into the passage 3, said liquid will move through the passage 3 at a high velocity. When the liquid enters the space 4, the liquid will substantially continue moving with a linear movement, so that the same will move on in a forward direction through the passage 3′. Due to the occurring shearing forces, the liquid will during it passage through the space 4 entrain a part of the medium present in said space 4 and carry it into the inlet opening 7. In the passage 3′, the liquid and the medium from space 4 will become intimately mixed and will discharge at outlet opening 8.

If the medium in the space 4 consist of a liquid, suspended in which is an abrasive, which is a solid, optionally supplemented with coagulants or the like, the mixture in the passage 3′ will only consist of substantially non-compressible materials. When this mixture exits via outlet opening 8 from passage 3′ into the ambient atmosphere, there will be no significant expansion of the material resulting from the change in pressure (in this case a reduction of pressure). The exiting jet of the abrasive mixture will therefore to large extent retain its diameter as determined by the channel 3′.

It has been shown that the exiting jet retains its shape over a relatively great length.

Even with a relatively small nozzle whose size needs to be only a few centimeters, i.e. 25 mm, a very consistent jet is obtained. The diameter D may be, for example, a mere 8 mm. The diameter D′ need not be more than approximately 4 mm. With such dimensions, the total length of the nozzle may be only 25 mm. The diameter of the passage 3′ is in that case, for example, 1 mm or less. Such a nozzle is suited to withstanding water pressures of up to minimally 500 MPa. Clearly the nozzles for application in the method according to the present invention may be embodied much smaller than has been possible up to now, where the abrasive was added to the liquid jet in the form of a mixture in air. This means that a much larger number of nozzles may be used in the liquid jet cutting device, so that finer patterns can be made with fewer operations.

In addition to the advantage that very fine water jets of small diameters may be obtained with the method and the nozzle according to the invention, the present invention also provides the advantage that the suspension containing the abrasive does not need to be highly pressurized. Another advantage is that the liquid needs to be less highly pressurized than has been customary up to now. An equally high pressure results in a higher cutting speed, while at a lower pressure the cutting speed remains the same.

According to a particular preference, the method is carried out with a simultaneous relative vertical movement of the nozzle in relation to the object to be cut. This makes it possible to very accurately make individual holes into a material. Moreover, this method makes it possible to make conical holes. In that case, at the side where the cutting jet is directed at the material, the cutting jet's diameter will be slightly larger than at the other side of the material. By means of this method it is possible to make holes (for example conical holes) into plate metal having a thickness of, for example, 0.1 to 1000 mm, which holes on both sides have a diameter of 0.1 to 10 mm, or in the case of conical holes, having a diameter on one side of 0.1 to 10 mm and on the other side a diameter of 0.2 to 12 mm. The cutting jet may have a diameter of, for example, 0.02 to 1 mm.

The cutter head may have an amplitude of, for example, 1.10⁻⁴ to 10⁻³ mm, preferably 0.1 to 20 mm, more preferably 0.1 to 10 mm, and still more preferably 0.2 to 5 mm.

The Frequency may be, for example, 10⁻⁴ to 10⁴ Hz, preferably 0.1 to 200 Hz. In practice the frequency is not important, since virtually any reduction in distance between the cutter and the material results in a cutting action. The frequency will therefore only be limited by the equipment to be used.

The distance from the cutter head to the material may be, for example, 0 to 1000 mm. Preferably the distance is 0.2 to 50 mm, especially 1-10 mm.

It will be obvious that with respect to the embodiment described above, the invention may be further adapted and modified without going beyond the scope of the idea of the invention as set forth in the appended claims. For example, the dimensions of the nozzle described as example may be varied within very broad limits.

1. A method for using a liquid-jet cutting device, comprising separately delivering a pressurized liquid medium and an abrasive medium to a nozzle, wherein the abrasive medium is delivered to the nozzle as suspension in a liquid, characterized in that the distance from the outlet of the nozzle to the object to be cut is varied during cutting.

2. A method according to claim 1, characterized in that the nozzle makes an oscillating movement with respect to the object to be cut during cutting.

3. A method according to claim 1, characterized in that the suspension is entrained by the liquid medium as a result of shearing forces.

4. A method according to claim 1, characterized in that the liquid medium and the suspension are mixed in an outlet duct.

5. A method according to claim 1, characterized in that the suspension is fed to the nozzle virtually without pressure or under low pressure.

6. A method according to claim 1, characterized in that the pressurized liquid is a similar liquid to the liquid of the suspension.

7. A nozzle for a liquid-jet cutting device, comprising inlets for a pressurized liquid and for an abrasive, which inlets are in communication with an outlet, characterized in that the nozzle comprises a passage extending directly from a first and forming the inlet side for the pressurized liquid to an opposite end forming the outlet, with the inlet for the abrasive being positioned between said ends, and wherein a sapphire is mounted near the inlet opening for the pressurized liquid, which sapphire comprises an opening that is coaxially aligned with the passage.

8. A nozzle according to claim 7, characterized in that a diameter of the sapphire opening is smaller that a diameter of the opening through the nozzle.

9. A nozzle according to claim 7, characterized in that the nozzle is made in one piece.

10. A nozzle according to claim 7, characterized in that the abrasive is present in the liquid as a suspension.

11. A nozzle according to claim 7, characterized in that the inlet for the abrasive suspension comprises means for connecting to a pipe in which substantially no pressure or low pressure prevails.

12. A nozzle according to claim 7, characterized in that sapphire opening is cylindrical.
